(19) United States
(12) Patent Application Publication
(10) Pub. No.: US 2026/0145600 A1
(43) Pub. Date: May 28, 2026

(54) VEHICLE SEAT FOR A MOTOR VEHICLE AND MOTOR VEHICLE

(71) Applicant: AUDI AG, Ingolstadt (DE)

(72) Inventor: Kathrin THALMANN, Unterschleissheim (DE)

(73) Assignee: AUDI AG, Ingolstadt (DE)

(21) Appl. No.: 19/352,697

(22) Filed: Oct. 8, 2025

(30) Foreign Application Priority Data
Nov. 26, 2024 (DE) 102024134779.1

(51) Int. Cl. B60N 2/64; B60N 2/02; B60N 2/90

(52) U.S. Cl. CPC B60N 2/64; B60N 2/02; B60N 2/90; B60N 2002/0216; B60N 2002/905

(57) ABSTRACT

Vehicle seat for a motor vehicle including a seat surface and a backrest. A storage device having a plate-shaped contact surface and a rail for holding a mobile terminal is arranged on a rear side of the backrest. The plate-shaped contact surface is pivotably coupled to the rail, and the rail has an electronic connection device for charging the mobile terminal. The rail has at least one pivotable first segment which can be pivoted from a non-use position, in which the electronic connection device is not accessible, into a use position in which the electronic connection device is accessible. The mobile terminal can be coupled to the electronic connection device at the same time when placed on the storage device.

### FIELD

The invention comprises a vehicle seat for a motor vehicle, comprising a seat surface and a backrest, wherein a storage device, comprising a plate-shaped contact surface and a rail, for holding a mobile terminal is arranged on a rear side of the backrest, wherein the plate-shaped contact surface is pivotably coupled to the rail, and wherein the rail has an electronic connection device for charging the mobile terminal. Furthermore, the invention relates to a motor vehicle.

### BACKGROUND

Currently, mobile devices such as smartphones, tablets or game consoles are often stored in motor vehicles out of the passenger's field of vision, for example in the center console, inside the glove compartment or in pockets located for example on the doors or vehicle seats. In addition or alternatively, the mobile devices are often held in place using clamps or gripper-like attachments, which often come from the after-market sector. If the mobile device and/or the vehicle do not offer the option of inductive charging, the mobile devices must be connected to a power source using a conventional USB cable for charging. The USB ports are often distributed throughout the vehicle and are therefore not always close to the passenger who wants to charge their mobile device. Accordingly, very long USB cables are often required so that the distance between the USB port and the occupant can be bridged. Currently, there is hardly any possibility for passengers in the second row of seats to store their mobile devices within their field of vision and charge them at the same time. Instead, the mobile devices are either held in the hands or fixed in subsequently purchased holders. This can be perceived as uncomfortable by the occupants and lead to dissatisfaction.

DE 10 2018 005 668 A1 describes a carrying device for attachment to a rear side of a backrest of a vehicle seat, wherein the carrying device is designed to hold a mobile terminal. The carrying device comprises a frame part, a background plate and an upper and a lower receiving rail for receiving the mobile terminal, wherein the lower receiving rail has a plurality of electronic connection devices via which the mobile terminal can be supplied with power.

DE 10 2020 207 048 A1 describes a vehicle with a vehicle seat arranged in a front area and a vehicle seat arranged in a rear area as well as an inductive charging station arranged in the rear area for inductively charging a communication terminal. The inductive charging station is located in a pocket that can be located, for example, on the back of a front seat backrest, on a headrest, a door panel, a headliner, or a center console.

US 2022/009 47 83 A1 describes a system for holding and inductively charging a mobile electronic device on a passenger seat. The system comprises a retention device with a carrier plate, a clamp arrangement for holding the mobile electronic device and an inductive charging station.

### SUMMARY

The invention is based on the object of providing an improved vehicle seat with which driving comfort can be increased with regard to the use of a mobile terminal.

To achieve this object, a vehicle seat according to the invention of the type mentioned at the outset is provided, in which the rail has at least one pivotable first segment which can be pivoted from a non-use position in which the electronic connection device is not accessible into a use position in which the electronic connection device is accessible, wherein the mobile terminal can be coupled to the electronic connection device at the same time when it is placed on the storage device.

In the non-use position, in which the electronic connection device is not accessible, it is arranged inside the rail. Only after a user has swivelled the first segment into the use position is the electronic connection device accessible so that a mobile device, in particular a smartphone, a tablet or an e-reader, can be charged. The first segment can advantageously be pivotable independently of the rail.

Preferably, the vehicle seat according to the invention is mounted as a front seat in the motor vehicle, wherein at least one rear seat is arranged behind this front seat. Accordingly, a passenger sitting in the rear seat has the advantage of being able to both store and charge their mobile device on the storage device located on the back of the front seat backrest. This means that the occupant no longer needs to carry his or her own charging cable while driving, but can instead use the electronic connection device built into the storage device. This increases the driving comfort of the occupant sitting in the rear seat, among other things, because they have access to the storage device and the charging facility integrated therein at any time during their stay in the vehicle and, for example, do not have to remember to take a cable with a USB port with them on every journey.

Furthermore, since the device has a uniform design in the non-use position without any protruding electronic connection device, functionality is advantageously combined with high-quality design.

Furthermore, the storage device is preferably arranged on the rear side of the backrest of the vehicle seat in such a way that in the event of an accident and/or heavy braking and an associated sudden forward movement of the upper body, in particular the head, of the occupant sitting on the rear seat, the occupant is not injured due to an impact on the storage device.

In a further development of the invention, the electronic connection device can have a connection element which is movably mounted in the first segment and can be pushed out of an opening of the segment when pivoting from the non-use position to the use position.

In the non-use position, the electronic connection device is arranged within the rail in such a way that it is not accessible and preferably not visible. The first segment may have an opening through which the electronic connection device, in particular the connection element, which is preferably a USB plug, can exit when the first segment is pivoted by the occupant. Accordingly, the electronic connection device can be movably mounted so that it is pushed out of the opening and is accessible when the segment is pivoted.

In the non-use position, the opening can be arranged on the first segment in such a way that it faces the occupant sitting on the rear seat. In order to reach the use position, the occupant can pivot the first segment upwards, e.g., by 80°-120°, in particular by 90°, relative to a vehicle vertical axis in the assembly position. During pivoting, the connection element can emerge from the opening of the first segment successively and depending on the degree or strength of the pivoting, wherein it can emerge completely in the use position. Accordingly, in the use position, the connection element can be used in such a way that the mobile terminal device can be plugged in, in particular in a vertical direction. In this embodiment, the mobile device can be advantageously held in its upright position by plugging it onto the connection element and simultaneously charged, thereby additionally combining functionality with an attractive design.

Conveniently, a cable which is accommodated in the rail in the non-use position can be connected to the connection element, wherein the connection element can be pulled out of the rail together with the cable in the use position.

The electronic connection device may preferably comprise the connection element and the cable. In the non-use position, this cable can be arranged inside the rail. After reaching the position of use, in which the connection element is in particular completely pushed out of the opening of the segment, it can be grasped by the occupant and pulled out of the rail together with the cable. This offers the advantage of increased flexibility for the occupant regarding the positioning of the mobile device during the loading process. This allows the occupant, for example, to charge their mobile device when placing it on the storage device in a horizontal position rather than an upright position, which is particularly advantageous when watching a film. In addition, the occupant can also be enabled to continue holding their mobile device in their hands while charging it and, if necessary, to bring it closer to their field of vision while simultaneously using an internal electronic charging option.

Alternatively or additionally, the connection element can also be grasped and pulled by the occupant during the pivoting process from the non-use position to the use position, so that the electronic connecting device can also be pulled out before the use position is reached. Due to the successive pushing out of the connection element from the opening of the first segment, it may be possible for the occupant to grasp and pull the connection element even before the connection element has completely exited the opening.

Preferably, a cable storage can be arranged within the rail, wherein in the non-pulled-out state at least a part of the cable is accommodated in the cable storage, wherein the cable can be pulled out of the cable storage, and wherein a spring mechanism is provided which builds up a restoring force when pulled out and via which the cable can be returned to the cable storage.

The cable storage can, for example, be a cable drum on which the cable is preferably wound. Accordingly, the cable can be wound on the cable storage when not in use and can be unwound from the cable storage when the cable is pulled out. The cable can preferably not be pulled out of the rail completely, but only partially. In particular, the part of the cable that is stored in the cable storage when not in use can be pulled out of the rail. Thus, in the pulled-out state, a first part of the cable can be arranged outside the rail, while a second part of the cable can be arranged inside the rail regardless of the position of the first segment or regardless of whether the first part of the cable is in the pulled-out state.

The cable can be conveniently pulled out to a stop. After reaching the stop, the cable can be completely unrolled in front of the cable storage. Furthermore, the cable storage can have a spring mechanism which builds up a restoring force when the cable is pulled out. In order to return the cable to the cable storage after use, the occupant can pull on the cable sharply, similar to a conventional vacuum cleaner cable, which releases a lock and allows the cable to be wound back onto the cable storage via the restoring force. This offers the advantage that the cable can always be stowed away after use and is not loose inside the vehicle

In a preferred development of the invention, the rail can have one or more further segments and the first segment and the further segment(s) can be arranged next to one another, wherein the first segment and the further segment(s) can be pivoted independently of one another.

Preferably, the rail can be segmented in several parts, wherein the segments can be arranged next to one another in a row and can be pivoted independently of one another. The rail and the segments can be cylindrical and hollow, which is particularly useful for accommodating the cable and the cable storage.

The individual segments can be connected to each other via corresponding grooves and tongues. In a configuration with three segments, for example, the middle segment, which may correspond to the first segment, may have at least one groove on each of its two outer sides, i.e., on the sides facing the two outer segments. Accordingly, the two outer segments can each have at least one spring on the sides facing the respective side of the middle segment, which can engage in the groove of the middle segment. Furthermore, the two outer segments can each have at least one further spring on the respective sides facing the rail, which can engage in a corresponding groove arranged on the rail. Of course, the middle segment can also contain the springs and the outer segments the grooves or a combination of grooves and springs.

In order to be able to move each segment independently of each other, the tongue and groove elements can be designed in such a way that the occupant presses over the tongue and groove fastening by moving one of the segments, so that the tongue can jump out of the groove and free movement of the respective segment is possible.

In addition, each segment can be provided with an additional groove or tongue into which the corresponding tongue or groove can snap when an end position is reached. For example, when the first segment is pivoted from the non-use position to the use position, the spring can jump out of the first groove and engage in a second groove when the use position is reached, so that the first segment is locked in the use position.

Preferably, the individual segments can each be pivoted by 90-120°, in particular 180°.

Conveniently, the first segment can be arranged between two further segments and the two further segments can each have a projection for holding a mobile terminal placed on the rail.

When not in use, the two further segments, which are preferably the two outer segments, can be in the same position as the first segment, i.e., in the non-use position. In this case, the projections of the two further segments can be flush with the first segment and face the occupant sitting in the rear seat. In order to enable the mobile device to be held, in particular when positioned transversely on the storage device, the two further segments can be pivoted upwards by 80°-120°, in particular 90°, on the occupant side, relative to a vertical axis of the vehicle in the mounting position, into a holding position.

When the mobile terminal is placed on the storage device in a transverse position, only the two further, i.e., outer, segments can be pivoted to hold the mobile terminal, wherein the first segment, which has the electronic connection device, is preferably in the non-use position. If the first segment is in the use position, the mobile device cannot be placed horizontally on the storage device because the exit of the connection element from the opening of the first segment prevents it from being placed in any position other than an upright position.

Preferably, the rail may have fastening elements by means of which the storage device can be fastened to the backrest.

The fastening elements can be conveniently screwed to the rail or connected in a form-fitting manner using tongue and groove elements. The fastening elements can be arranged in particular within the backrest, for example in the upholstery below the cover, so that the fastening elements are advantageously not visible. Preferably, the fastening elements have the same shape as the rail and are thus cylindrical and hollow. As an alternative to the above-mentioned design variant, in which the cable storage is arranged within the rail, the cable storage can also be arranged within the fastening elements.

Furthermore, in the mounting position, the rail can be arranged on the backrest below the plate-shaped contact surface. The rail can in particular be arranged at a lower end of the plate-shaped contact surface, whereby the rail can be used advantageously for holding and storing the mobile terminal device.

According to a preferred development of the invention, the rear side of the backrest can have a recess corresponding at least to the area of the plate-shaped contact surface, wherein the plate-shaped contact surface can be pivotally mounted and can be pivoted from a first position, in which the contact surface covers the recess and is flush with the rear side of the backrest, into the recess into a second position, wherein in the second position a support surface is formed on the rail for holding the mobile terminal.

In the first position, the plate-shaped contact surface can be arranged on the backrest in such a way that the recess within the backrest is not visible, thus ensuring a uniform and high-quality design. In this first position, it is preferably not possible to place the mobile device on the storage device or to charge the mobile device. Only after the occupant has pivoted the plate-shaped support surface into the second position, i.e., into the recess of the backrest, can a support surface be formed on the rail which is dimensioned in such a way that a mobile device can be placed on it and, if necessary, charged. In the second position, the plate-shaped contact surface can be pressed into the recess as far as it will go, so that the plate-shaped contact surface rests, for example, against a rear wall of the recess.

As already noted, the segments can be pivoted independently of the rail or the plate-shaped contact surface, so that pivoting of the plate-shaped contact surface from the first position to the second position or, conversely, no pivoting of the segments results.

In contrast to conventional storage devices, which can be pivoted in particular in the direction of the occupant, the storage device according to the invention offers the advantage that, in particular in the event of a sudden forward movement of the head or upper body of the occupant, for example due to heavy braking and/or an accident, an impact of the head or upper body on the storage device can be prevented, since the latter can be pivoted into the backrest and thus away from the occupant, whereby the risk of injury can be minimized.

The plate-shaped contact surface can expediently have a push-push mechanism by means of which the plate-shaped contact surface can be automatically moved from the second position to the first position. The plate-shaped contact surface can preferably be locked in the second position. To return from the second position to the first position, the occupant can press on the plate-shaped contact surface, whereby the lock can be released by means of the push-push mechanism and the plate-shaped contact surface automatically returns to the first position. This offers the advantage of comfortable and easy handling when pivoting between the two positions.

It is of course also conceivable that the occupant can pivot the plate-shaped contact surface into any position between the first and the second position. This means that the occupant can, for example, only push the plate-shaped system halfway into the recess. However, in order for the plate-shaped contact surface to be able to return from this position to the first position, the occupant must first move the plate-shaped contact surface to the second position so that the push-push mechanism can be triggered.

The invention also relates to a motor vehicle comprising at least one vehicle seat of the type described above.

### BRIEF DESCRIPTION OF THE FIGURES

Further advantages and details of the present invention will be apparent from the exemplary embodiments described below and in reference to the drawings. In particular:

FIG. 1 shows a schematic diagram of a vehicle seat according to the invention comprising a storage device, wherein a plate-shaped contact surface is arranged in a first position and a first segment is arranged in a non-use position,

FIG. 2 shows a schematic diagram according to FIG. 1, wherein the plate-shaped contact surface is arranged in a second position within a recess and the first segment is arranged in a use position for charging a mobile terminal in an upright position,

FIG. 3 shows a schematic diagram according to FIG. 2, wherein an electronic connection device is pulled out of the first segment so that the mobile terminal can be charged in a transverse position,

FIG. 4 shows schematic diagram of the storage device that can be arranged on the vehicle seat according to the invention, and

FIG. 5 shows schematic diagram of a motor vehicle according to the invention with a vehicle seat according to the invention.

### DETAILED DESCRIPTION

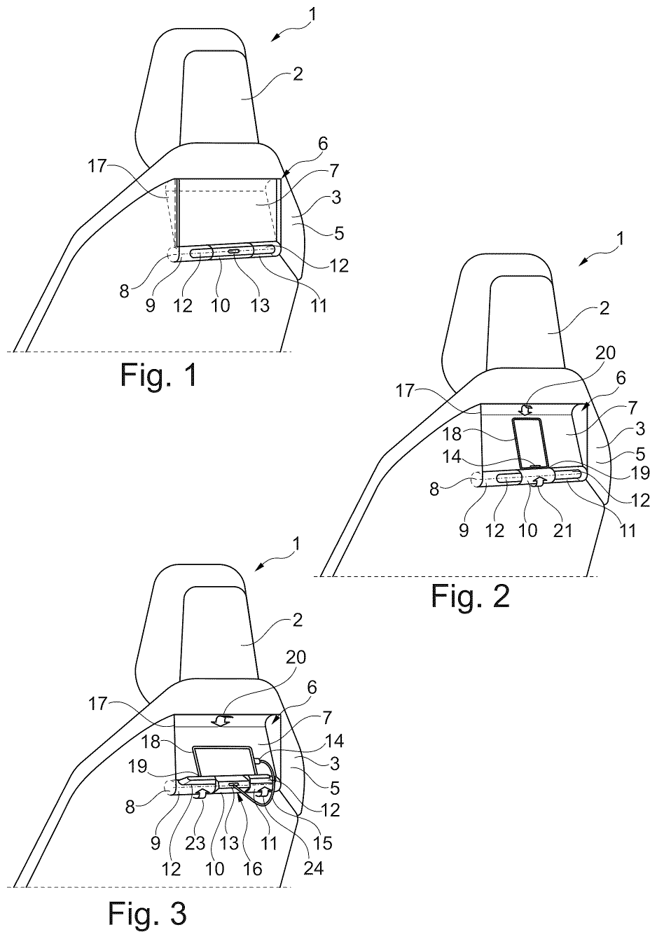

FIG. 1 to FIG. 3 show a vehicle seat 1 according to the invention, comprising a headrest 2 and a backrest 3. On a rear side 5 of the backrest 3, a storage device 6, comprising a plate-shaped contact surface 7 and a rail 8, is arranged, wherein the plate-shaped contact surface 7 is pivotably coupled to the rail 8. The backrest 3 furthermore has a recess 17 which corresponds to the area of the plate-shaped contact surface 7 and into which the plate-shaped contact surface 7 can be pressed if necessary.

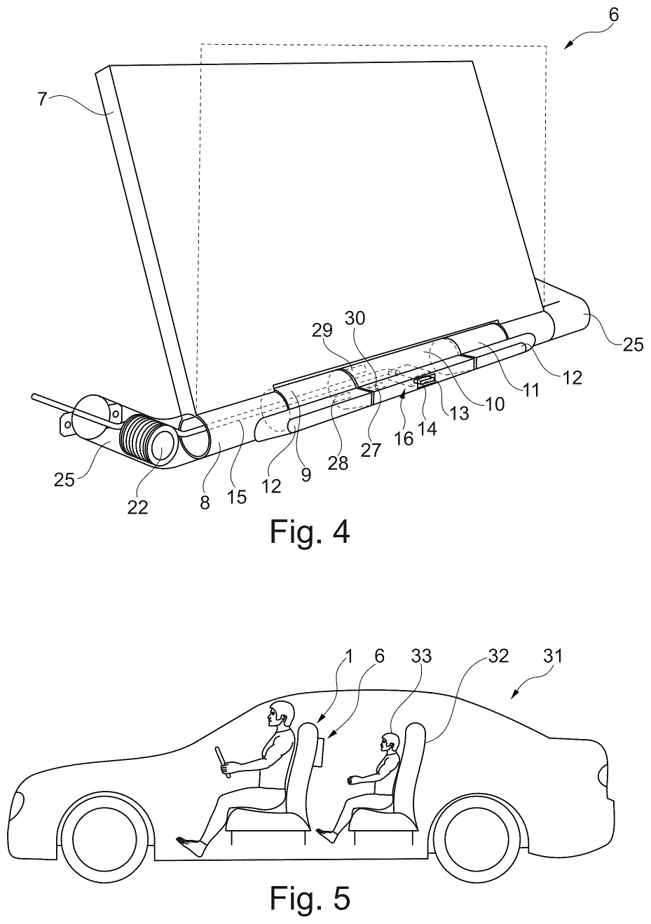

FIG. 4 shows a detailed representation of the storage device 6 comprising an electronic connection device 16 arranged within the rail and a cable storage 22.

The rail 8 shown in FIG. 1 to FIG. 3 is arranged below the plate-shaped contact surface 7 with respect to an assembly position of the vehicle seat 1, so that a mobile terminal device not shown in FIG. 1, such as a smartphone, a tablet or an e-reader, can be held. An electronic connection device 16, comprising a connection element 14, for example a USB plug, and a cable 15, is arranged within the rail, by means of which the mobile terminal 18 can be charged as needed (see FIG. 4). Furthermore, the rail 8 has three segments 9, 10, 11, which are arranged next to each other in a row. The three segments 9, 10, 11 can be pivoted independently of each other and independently of the rail 8. The two outer segments 9 and 11 each have a projection 12. The middle segment 10, the segment previously referred to as the first segment, has an opening 13 through which the connection element 14 and the cable 15 of the electronic connection device 16, which are movably mounted, can emerge.

The storage device 6 is arranged on the rear side of the backrest 3 in such a way that it is in the field of vision of an occupant who is located behind the vehicle seat 1 according to the invention and, for example, sits on another vehicle seat not shown in FIGS. 1 to 4, so that the occupant can comfortably operate the storage device 6.

In the vehicle seat shown in FIG. 1, the plate-shaped contact surface 7 is in a first position in which the plate-shaped contact surface 7 is flush with the rear side 5 of the backrest 3, so that a uniform and high-quality design of the vehicle seat 1 is ensured. In this position, it is preferably not possible for the occupant to place the mobile terminal 18 on the storage device 6.

Furthermore, the middle segment 10 is in a non-use position in which the opening 13 faces the occupant who is preferably arranged behind the vehicle seat 1 according to the invention. In the non-use position, the electronic connection device 16 is completely located in the rail 8, so that the electronic connection device 16, in particular the connection element 14, is neither visible nor accessible to the occupant.

FIG. 2 shows the vehicle seat 1 according to the invention in which the plate-shaped contact surface 7 is pivoted into a second position in the direction of the recess 17 and the middle segment 10 is pivoted into a use position.

When the plate-shaped contact surface 7 is pivoted into the recess 17, as shown by the arrow 20, a support surface 19 is formed on the rail 8, which is dimensioned such that the mobile terminal 18 can be placed thereon. The area of the support surface becomes proportionally larger the further the plate-shaped contact surface 7 is pressed into the recess 17.

To charge the mobile terminal 18, the occupant pivots the middle segment 10, relative to an assembly position of the vehicle seat 1, from the non-use position upwards into a use position, as shown by the arrow 21. During pivoting, the movably mounted connection element 14 successively emerges from the opening 13 of the middle segment 10, i.e., it is pushed out, wherein when the use position is reached, the connection element 14 has completely emerged from the opening 13. In this position, the occupant is now able to plug his mobile device 18 onto the connection element 14 for charging, which also holds it at the same time. If the segment 10 were pivoted back from the use position into the non-use position, the connection element 14 would be retracted into the rail 8. In this position, it is therefore coupled in terms of movement with rail 8 or segment 10.

FIG. 3 shows the vehicle seat 1 according to the invention, wherein the plate-shaped contact surface 7 is located in the second position within the recess 17 and the connection element 14 and the cable 15 are pulled out of the opening 13 of the middle segment 10.

As an alternative to charging the mobile terminal 18 in an upright position as shown in FIG. 2, it is also possible for the occupant to charge the mobile terminal 18, for example, in a transverse position and to hold it at the same time. If the middle segment 10 is in the use position in which the connection element 14 has completely emerged from the opening 13, the occupant can grasp the connection element 14 and pull it. Alternatively or additionally, the occupant can also pull on the connection element 14 if the connection element 14 has not yet completely emerged from the opening 13, but in particular far enough that it is within reach of the occupant. By pulling, the cable 15 is unwound from a cable storage 22 explained in more detail in FIG. 4 and exits at least partially from the opening 13.

By pulling out the cable 15 and the connection element 14 arranged thereon, the occupant is able to charge the mobile terminal 18 in a position other than an upright position, in particular in a transverse position. In order to place the mobile terminal 18 on the support surface 19 of the rail, the occupant pivots the middle segment 10, from whose opening 13 the connection element 14 and the cable 15 have already emerged, back into the non-use position and places the mobile terminal transversely on the support surface 19. The occupant can then couple the mobile terminal to the connection element 14 so that it is charged.

In order to prevent the mobile terminal 18 from slipping and/or falling down in this position, the two outer segments 9, 11 are pivoted upwards relative to the mounting position of the vehicle seat 1, as shown by the two arrows 23, 24, so that the two projections 12 preferably rest against the mobile terminal 18.

FIG. 4 shows an enlarged and more detailed schematic diagram of the storage device 6 arranged on the vehicle seat 1 according to the invention.

The plate-shaped contact surface 7 is shown by means of a dashed line in the first, non-pivoted position and by means of a continuous line in the second, pivoted position. The plate-shaped contact surface 7 additionally has a push-push mechanism by means of which the plate-shaped contact surface 7 can be automatically moved back into the first position after being locked in the second position. Accordingly, by applying pressure to the plate-shaped contact surface 7, the push-push mechanism can be triggered, whereby the locking mechanism is released and the plate-shaped contact surface 7 moves back to the first position.

The rail 8 is in particular cylindrical and hollow, which serves to accommodate the electronic connection device 16. At each of the outer ends of the rail 8, a fastening element 25 is arranged, which serves to fasten the storage device 6 to the vehicle seat 1. The fastening elements 25 are shown grayed out here, which makes it clear that they are not visibly arranged within the vehicle seat 1, for example within a cushion of the backrest 3. The fastening elements 25 continue the rail 8, so that the fastening elements 25 according to this embodiment are also cylindrical and hollow.

Within one of the fastening elements, the cable storage 22 is arranged, on which the cable 15 of the electronic connection device 16 is wound in the non-use position. Alternatively, the cable storage 22 can also be arranged within the rail 8. When the cable 15 is pulled out of the rail 8, it is unwound from the cable storage 22 so that at least a part of the cable 15 arranged in the rail 8 can be pulled out of the rail 8. When the cable 15 is pulled out of the rail 8, a restoring force is generated by a spring mechanism provided on the cable storage 22. By jerking the pulled-out cable 15, a locking mechanism is released and the cable 15 can be returned to the rail 8 together with the connection element 14 via the restoring force. When the cable 15 is returned, it is wound up again on the cable storage 22.

Three adjacent segments 9, 10, 11 are arranged on the rail 8, wherein, as already explained, the two outer segments 9, 11 each have a projection 12 for holding the mobile terminal 18 and the middle segment 10 has the opening 13 through which the connection element 14 emerges when the middle segment 10 is pivoted from the non-use position into the use position. The segments are connected to each other via grooves 27, 28, 29 and springs 30. It should be noted that for reasons of better clarity in FIG. 4 the corresponding grooves 27, 28, 29 and tongues 30 are shown only on one side of the middle segment 10.

The middle segment 10, for example, has a first groove 27 on each of its two outer sides, which face the respective outer segments 9, 11. In the non-use position of the middle segment 10 or the non-pivoted position of the two outer segments 9, 11, a spring 30 engages in this first groove 27, which is arranged on the side of the respective outer segment 9, 11 that faces the respective side of the middle segment 10. When one of the segments 9, 10, 11 is pivoted, the respective tongue and groove elements 27, 30 are overpressed so that the tongue 30 jumps out of the first groove 27. In addition, a second groove 28 and a third groove 29 are arranged on both sides of the middle segment 10. When the middle segment 10 is pivoted from the non-use position into the use position, the spring 30 jumps out of the first groove 27 and engages in the second groove 28 as soon as the middle segment 10 is in the use position. Conversely, when one of the outer segments 9, 11 is pivoted into a holding position, the spring 30 jumps out of the first groove 27 and engages in the third groove 29 as soon as one of the outer segments 9, 11 has reached the holding position. Accordingly, locking of the respective segments 9, 10, 11 in the use position or the holding position can be ensured. Alternatively, another combination of grooves 27, 28, 29 and springs 30 can be arranged on the segments 9, 10, 11.

FIG. 5 shows the schematic arrangement of at least one vehicle seat 1 according to the invention and of a further vehicle seat 32 arranged in the rear area within a motor vehicle 31, on which an occupant 33 sits to operate the storage device 6 arranged on the vehicle seat 1.

1. A vehicle seat for a motor vehicle, comprising: a seat surface and a backrest, wherein a storage device having a plate-shaped contact surface and a rail for holding a mobile terminal is arranged on a rear side of the backrest, wherein the plate-shaped contact surface is pivotably coupled to the rail, and wherein the rail has an electronic connection device for charging the mobile terminal, wherein the rail has at least one pivotable first segment which can be pivoted from a non-use position, in which the electronic connection device is not accessible, into a use position in which the electronic connection device is accessible, wherein the mobile terminal can be coupled to the electronic connection device at the same time when placed on the storage device.

2. The vehicle seat according to claim 1, wherein the electronic connection device has a connection element which is movably mounted in the first segment and can be pushed out of an opening of the segment when pivoting from the non-use position into the use position.

3. The vehicle seat according to claim 2, wherein a cable which is accommodated in the rail in the non-use position is connected to the connection element, wherein the connection element can be pulled out of the rail together with the cable in the use position.

4. The vehicle seat according to claim 3, wherein a cable storage is arranged within the rail, wherein in the non-pulled-out state at least part of the cable is accommodated in the cable store, wherein the cable can be pulled out of the cable storage, and a spring mechanism is provided which builds up a restoring force when pulled out and via which the cable can be returned to the cable storage.

5. The vehicle seat according to claim 1, wherein the rail has one or more further segments and the first segment and the further segment(s) are arranged next to one another, wherein the first segment and the further segment(s) are pivotable independently of one another.

6. The vehicle seat according to claim 5, wherein the first segment is arranged between two further segments and the two further segments each have a projection for holding a mobile terminal placed on the rail.

7. The vehicle seat according to claim 1, wherein the rail has fastening elements by which the storage device can be fastened to the backrest.

8. The vehicle seat according to claim 1, wherein the rail is arranged in the mounting position on the backrest below the plate-shaped contact surface.

9. The vehicle seat according to claim 1, wherein the rear side of the backrest has a recess corresponding at least to the surface of the plate-shaped contact surface, wherein the plate-shaped contact surface is pivotally mounted and can be pivoted from a first position, in which the contact surface covers the recess and is flush with the rear side of the backrest, into the recess into a second position, wherein in the second position a support surface is formed on the rail for holding the mobile terminal.

10. The vehicle seat according to claim 9, wherein the plate-shaped contact surface has a push-push mechanism by means of which the plate-shaped contact surface is automatically moved from the second position to the first position.

11. A motor vehicle comprising at least one vehicle seat according to claim 1.

12. The vehicle seat according to claim 2, wherein the rail has one or more further segments and the first segment and the further segment(s) are arranged next to one another, wherein the first segment and the further segment(s) are pivotable independently of one another.

13. The vehicle seat according to claim 3, wherein the rail has one or more further segments and the first segment and the further segment(s) are arranged next to one another, wherein the first segment and the further segment(s) are pivotable independently of one another.

14. The vehicle seat according to claim 4, wherein the rail has one or more further segments and the first segment and the further segment(s) are arranged next to one another, wherein the first segment and the further segment(s) are pivotable independently of one another.

15. The vehicle seat according to claim 2, wherein the rail has fastening elements by which the storage device can be fastened to the backrest.

16. The vehicle seat according to claim 3, wherein the rail has fastening elements by which the storage device can be fastened to the backrest.

17. The vehicle seat according to claim 4, wherein the rail has fastening elements by which the storage device can be fastened to the backrest.

18. The vehicle seat according to claim 5, wherein the rail has fastening elements by which the storage device can be fastened to the backrest.

19. The vehicle seat according to claim 6, wherein the rail has fastening elements by which the storage device can be fastened to the backrest.

20. The vehicle seat according to claim 2, wherein the rail is arranged in the mounting position on the backrest below the plate-shaped contact surface.
